(19) United States
(12) Patent Application Publication
(10) Pub. No.: US 2023/0202415 A1
(43) Pub. Date: Jun. 29, 2023

(54) VEHICLE BODY FRONT STRUCTURE

(71) Applicant: HONDA MOTOR CO., LTD., Tokyo (JP)

(72) Inventors: Hirotoshi TAMURA, Wako-shi, Saitama (JP); Daisuke AMEMIYA, Wako-shi, Saitama (JP); Satoshi HAYASHI, Wako-shi, Saitama (JP); Chaewook LEE, Wako-shi, Saitama (JP)

(21) Appl. No.: 17/926,777

(22) PCT Filed: Jun. 5, 2020
(86) PCT No.: PCT/JP2020/022346

§ 371 Date: Nov. 21, 2022

(51) Int. Cl. B60R 19/52

(52) U.S. Cl. CPC B60R 19/52; B60R 2019/527

(57) ABSTRACT

A vehicle body front structure includes a hood provided at an opening formed in a front part of a vehicle, a bumper located more frontward than the hood, and a grille provided as a part of the bumper. Each of the hood, the bumper, and the grille is at least partially provided with an identically inclined surface portion such that when viewed in a plane perpendicular to a vehicle width direction, positions of surfaces of the hood, the bumper, and the grille that are adjacent to each other are flush with each other in an out-of-plane direction.

### TECHNICAL FIELD

The present invention relates to a vehicle body front structure.

### BACKGROUND ART

As a conventional front structure of a vehicle, there is known a structure in which an attachment portion between a grille and a bracket is sheared to absorb impact (e.g., Patent Literature 1).

### CITATION LIST

### Patent Literature

Patent Literature 1: JP2016-78664A

### SUMMARY OF INVENTION

### Technical Problem

This Patent Literature does not disclose details about the positional relationship between a hood, a bumper, and a grille in a front structure of a vehicle, and there is room for further improvement in external appearance quality.

This invention aims to provide a vehicle body front structure that can further improve external appearance quality by providing continuity with other parts.

### Solution to Problem

A vehicle body front structure according to the present invention comprises: a hood provided at an opening formed in a front part of a vehicle; a bumper located more frontward than the hood; and a grille provided as a part of the bumper, wherein each of the hood, the bumper, and the grille is at least partially provided with an identically inclined surface portion such that when viewed in a plane perpendicular to a vehicle width direction of the vehicle, surfaces of the hood, the bumper, and the grille that are adjacent to each other are inclined at an approximately identical angle.

### Advantageous Effects of Invention

The vehicle body front structure according to the present invention can further improve external appearance quality by providing continuity with other parts.

### BRIEF DESCRIPTION OF DRAWINGS

FIG. 1 is a perspective view of a vehicle explaining the overall configuration of a bumper including a grille in a vehicle body front structure according to an embodiment of the present invention.

FIG. 2 is a left side view of the vehicle explaining the vehicle body front structure according to the embodiment, in which a hood, a bumper, and a grille are attached.

FIG. 3 is a perspective view of the front side of the vehicle explaining the configuration of the vehicle body front structure according to the embodiment, in which the license plate has been removed.

FIG. 4 is a cross-sectional view of the vehicle body front structure according to the embodiment taken in the direction perpendicular to the vehicle width direction, in which the license plate is attached.

FIG. 5 is a left side view of a vehicle explaining a vehicle body front structure according to a modification of the embodiment, in which a hood, a bumper, and a grille are attached.

### DESCRIPTION OF EMBODIMENTS

One embodiment of the present invention will be described below with reference to the drawings where appropriate. The same or similar constituent elements are designated by the same reference numerals and duplicated descriptions thereof will be omitted. The same or similar constituent elements are designated by the same reference numerals and duplicated descriptions thereof will be omitted. Unless otherwise stated, directions such as front, rear, right, left, upper and lower basically correspond to the directions as seen from a driver. It should be noted that “vehicle width direction” and “lateral direction (right-left direction)” are interchangeable.

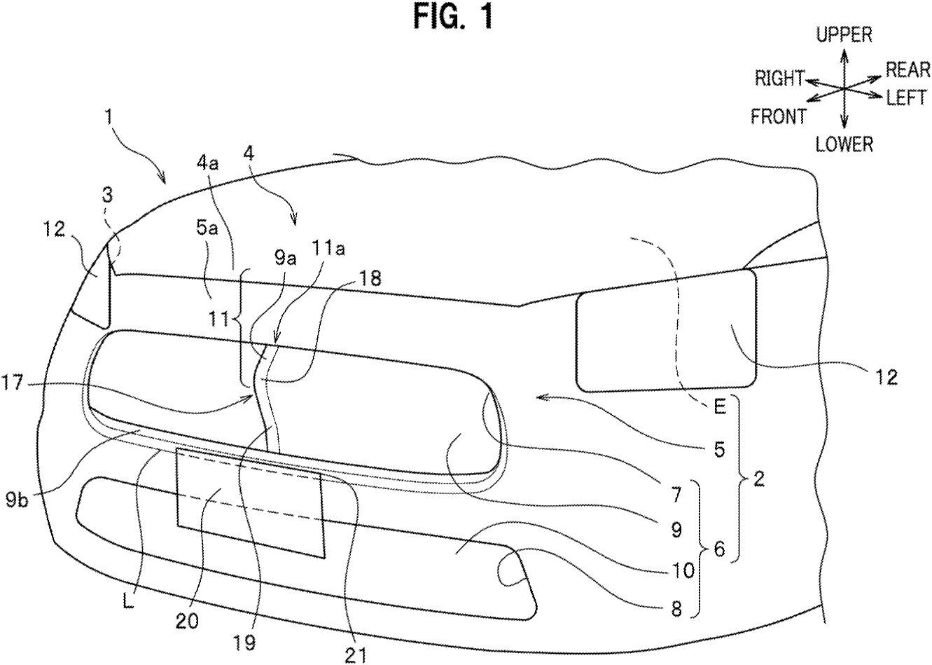

As seen in FIG. 1, in a vehicle body front structure according to this embodiment, a power compartment E is provided in a front part 2 of a vehicle 1. An opening 3 is formed in an upper surface of the power compartment E. The opening 3 connects a space inside the power compartment E with the outside space in an upper-lower direction. A bumper 5, a grille 6, and a pair of right and left head lights 12, 12 are provided at the front side of the power compartment E.

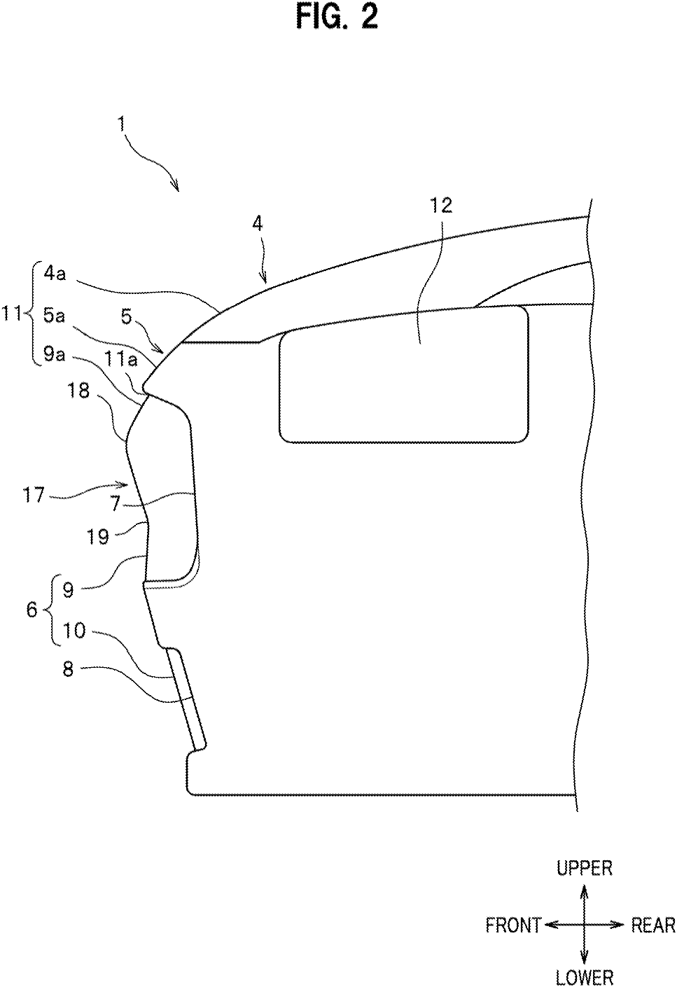

A hood 4 that can be opened and closed is provided at the opening 3. The hood 4 is formed in the form of a generally rectangular flat plate as viewed from above. The upper surface 4a of the hood 4 is curved to protrude upward. The front edge portion of the hood 4 is formed to gradually descend toward the front side of the vehicle (see FIG. 2).

The bumper 5 is located at a position more frontward than the hood 4 and below the hood 4. The bumper 5 extends in the vehicle width direction substantially throughout the entire width of the vehicle 1.

The bumper 5 according to this embodiment has an upper grille opening 7 and a lower grille opening 8 that are arranged vertically. The upper grille opening 7 is formed as an oval shape, and the longitudinal direction of the upper grille opening 7 extends in the vehicle width direction. The longitudinal direction of the lower grille opening 8 extends in the vehicle width direction, and the lower grille opening 8 may have an upper half in the shape of an oval and a lower half opened toward the lower side of the vehicle.

As seen in FIG. 2, an upper side of the bumper 5 is provided between an upper edge of the upper grille opening 7 and a front edge portion of the hood 4. The surface 5a of the upper side of the bumper 5 is formed to gradually descend toward the front side of the vehicle.

According to this embodiment, the surface 5a of the upper side of the bumper 5 and the surface 4a of the front edge portion of the hood 4 are abutted in the same vertical position and flush with each other in an out-of-plane direction. At the abutted portion between the surface 4a and the surface 5a, the inclination angles of the adjacent surfaces are identical to each other toward the front side of the vehicle 1 to form an identically inclined surface portion 11.

The bumper 5 is provided with the grille 6 as a part of the bumper 5. The grille 6 is divided into an upper grille 9 and a lower grille 10.

The upper grille 9 is mounted in the upper grille opening 7, whereas the lower grille 10 is mounted in the lower grille opening 8.

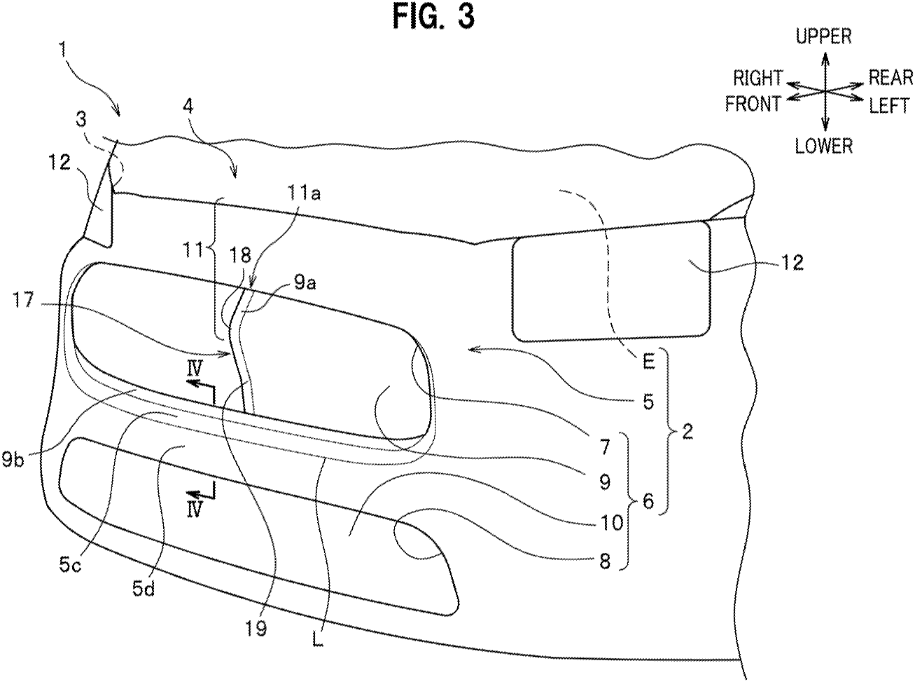

As seen in FIG. 3, the upper grille 9 of this embodiment has a plurality of main pillars 17.

Each of the main pillars 17 is long in the upper-lower direction of the vehicle and formed to have a tall fin shape having a constant width dimension. The main pillars 17 are arranged substantially throughout the entire width of the upper grille opening 7 in the vehicle width direction. The main pillars 17 are spaced apart at regular intervals so that they are almost equally spaced apart from each other.

Each main pillar 17 has a first curved portion 18 that curves to protrude forward at a middle portion of the main pillar 17 in the upper-lower direction.

The first curved portions 18 of this embodiment have chevron vertices provided substantially at the same vertical positions of the main pillars 17 as viewed from front. The vertices are horizontally aligned substantially along the horizontal straight line in the vehicle width direction.

In the upper grille 9 of this embodiment, the main pillar 17 that is disposed in the center of the upper grille 9 in the vehicle width direction is located at the forwardmost position. The plurality of other main pillars 17 are located rearward of the central main pillar 17 and arranged laterally symmetrically across the central main pillar 17. In the upper grille 9, the plurality of main pillars 17 are arranged in an arc shape, when viewed from above, to protrude forward at the middle in the vehicle width direction.

Each of the main pillars 17 of the upper grille 9 has a second curved portion 19 that curves to protrude rearward under the first curved portion 18.

Accordingly, each of the main pillars 17 of this embodiment is curved to meander in a generally S-shape as viewed from side with the first curved portion 18 protrude frontward and the second curved portion 19 protrude rearward.

According to the vehicle body front structure of this embodiment, as seen in FIG. 2, each of the hood 4, the bumper 5, and the upper grille 9, which are disposed between right and left headlights 12, 12 in the vehicle width direction, is provided with an identically inclined surface portion 11 such that surfaces thereof adjacent to each other are inclined at an identical inclination angle. The identically inclined surface portion 11 is formed such that when viewed in a plane perpendicular to the vehicle width direction, the surface 4a of the front edge portion of the hood 4, the surface 5a of the upper side of the bumper 5, and the upper surface 9a of the upper grille 9 that is formed on the main pillar 17 above the first curved portion 18, which are adjacent to each other, are inclined at an identical inclination angle.

In other words, the identically inclined surface portion 11 according to this embodiment is set such that the inclination angles of the surfaces 4a, 5a are identical to each other to the same inclination angle at the abutted portion where the hood 4 and the bumper 5 adjacent to each other are abutted together.

The identically inclined surface portion 11 is set such that the inclination angles of the surface 5a of the upper side of the bumper 5 and the surface 9a of the upper edge portion of the upper grille 9, which are adjacent to each other, are identical to each other to the same inclination angle.

Further, the identically inclined surface portion 11 is formed such that when viewed in a plane perpendicular to the vehicle width direction, the surfaces 4a, 5a adjacent to each other are located at the same positions and flush with each other in the out-of-plane direction.

Further, the surface 5a of the upper side and the surface 9a of the upper grille 9 are located at different positions in the out-of-plane direction, so that a predetermined step 11a is formed between the surface 5a of the upper side and the surface 9a of the upper grille 9. The step 11a according to this embodiment is set such that the surface 9a of the upper grille 9 is one step lower than the surface 5a of the bumper 5.

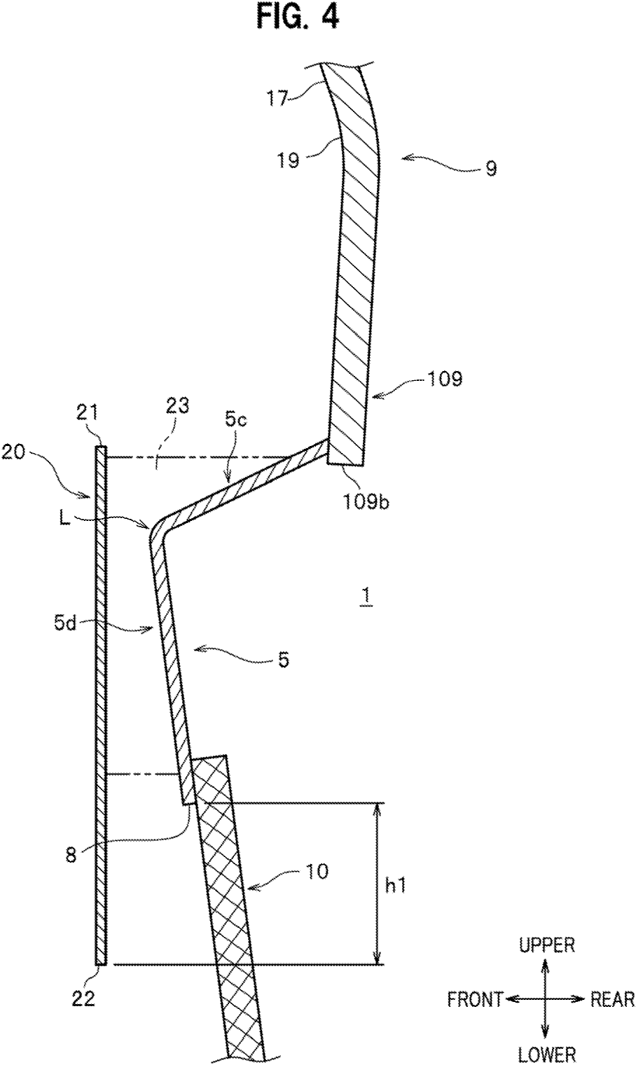

A license plate 20 as shown in FIG. 1 is disposed frontward of the grille 6 according to this embodiment. FIG. 4 shows a structure for attaching the license plate 20 of this embodiment to the vehicle.

According to this embodiment, the vertical position of the upper end 21 of the license plate 20 coincides with the vertical position of the lower end 9b of the upper grille 9 in the upper-lower direction.

The lower end 22 of the license plate 20 protrudes downward toward the lower grille opening 8 by a predetermined dimension h1. For this reason, the lower end 22 is positioned frontward of the lower grille 10. When viewed from the front side of the vehicle 1, the upper edge portion of the lower grille 10 and the lower end 22 of the license plate 20 overlap with each other in the upper-lower direction.

As seen in FIG. 3, a ridge line L protrudes frontward and extends in the vehicle width direction between the upper grille 9 and the lower grille 10 of the bumper 5.

The bumper 5 is attached to the vehicle 1 using an attachment fixture 23. The attachment fixture 23 is attached to the vehicle 1 at a laterally middle position in the vehicle width direction astride the ridge line L in the upper-lower direction. The back side of the license plate 20 is fixed to the front side of the attachment fixture 23. The license plate 20 is attached to and thus supported by the bumper 5, astride the ridge line L.

As seen in FIG. 4, the bumper 5 includes a first surface 5c that is located below the ridge line L and a second surface 5d that is located above the ridge line L. When viewed in a plane perpendicular to the vehicle width direction, the first surface 5c and the second surface 5d intersect substantially at orthogonal angles. Accordingly, the out-of-plane directions of the first surface 5c and the second surface 5d are oriented diagonally upward and downward.

The license plate 20 of this embodiment is attached to the first surface 5c and the second surface 5d using the attachment fixture 23.

Operation and effects of the vehicle body front structure according to this embodiment will be described below.

As seen in FIG. 1, the vehicle body front structure according to this embodiment includes the hood 4 provided at the opening 3 formed in the front part 2 of the vehicle 1, the bumper 5 located more frontward than the hood 4, and the grille 6 provided as a part of the bumper 5. As seen in FIG. 2, each of the hood 4, the bumper 5, and the grille 6 is at least partially provided with the identically inclined surface portion 11 such that when viewed in a plane perpendicular to the vehicle width direction, either the surface 4a of the hood 4 and the surface 5a of the bumper 5 adjacent to each other or the surface 5a of the bumper 5 and the surface 9a of the grille 6 adjacent to each other are inclined at an identical inclination angle.

As such, it is possible to further improve external appearance quality by providing continuity with other adjacently located parts. To be more specific, among the hood 4, the bumper 5, and the grille 6 adjacent to each other as shown in FIG. 3. the surface 4a of the hood 4 and the surface 5a of the bumper 5 adjacent to each other and the surface 5a of the bumper 5 and the surface 9a of the main pillar 17 of the upper grille 9 adjacent to each other are the identically inclined surface portion 11, at which the inclination angles thereof are identical. Even if the step 11a is formed, continuity in design occurs at the identically inclined surface portion 11 from the hood 4 to the grille 6 through the bumper 5. For this reason, the external appearance quality can be improved at the front part 2 of the vehicle 1.

The grille 6 includes the main pillar 17 extending in the upper-lower direction. The main pillar 17 has the first curved portion 18 that curves to protrude forward at a middle portion of the main pillar 17 in the upper-lower direction.

As such, setting a vertex of the first curved portion 18 that protrude forward at the vertically middle portion contributes to a change in the main pillar 17. For this reason, the degree of freedom in modeling can be improved to further improve the external appearance quality.

According to this embodiment, the plurality of main pillars 17 are arranged at predetermined intervals in the vehicle width direction. As such, when viewed from the front side of the vehicle, the plurality of first curved portions 18, each of which protrudes forward from the main pillar 17, can be horizontally aligned substantially along the horizontal straight line in the vehicle width direction.

Further, in the upper grille 9 of this embodiment, the main pillar 17 that is disposed in the center in the vehicle width direction is located at the forwardmost position, while the plurality of other main pillars 17 are arranged laterally symmetrically in the vehicle width direction.

For example, when viewed from above, the upper grille 9 curves in an arc shape to protrude forward at the first curved portions 18, so that a three-dimensional shape can be obtained. For this reason, it is possible to further improve the external appearance quality.

Further, as seen in FIG. 3, the main pillar 17 of the grille 6 has the second curved portion 19 that curves to protrude rearward under the first curved portion 18.

At the front part 2 of the vehicle 1 according to this embodiment, the main pillars 17 are configured such that the first curved portions 18 protrude forward and the second curved portions 19 protrude rearward. As such, the upper grille 9 bulges alternately forward and rearward to protrude forward and rearward at the first curved portions 18 and the second curved portions 19. For this reason, the vehicle 1 can improve the efficiency in absorbing impact thanks to a deformation of the upper grille 9 upon frontal collision of the vehicle 1.

Further, as seen in FIG. 1, the vehicle body front structure according to this embodiment includes the license plate 20 that is disposed frontward of the grille 6.

The grille 6 is divided into the upper grille 9 and the lower grille 10.

As seen in FIG. 4, the vertical position of the upper end 21 of the license plate 20 coincides with the vertical position of the lower end 9b of the upper grille 9 in the upper-lower direction.

In this embodiment, the vertical dimension between the first surface 5c and the second surface 5d of the bumper 5 that is formed between the upper grille 9 and the lower grille 10 can be minimized in the upper-lower direction, so that parts can be made compact and the weight thereof can be reduced more efficiently.

Moreover, the license plate 20 is not present in the air passage when air is introduced through the upper grille 6. Therefore, the volume of air contacting the license plate 20 upon introducing the air into the grille 6 can be reduced to suppress generation of air resistance. As such, better cooling efficiency can be obtained.

Further, as seen in FIG. 4, the lower end 22 of the license plate 20 and the upper edge portion of the lower grille 10 overlap with each other in the upper-lower direction when viewed from the front side of the vehicle 1.

As such, as compared with an alternative configuration in which the lower end 22 and the lower grille 10 do not overlap with each other in the upper-lower direction, the vertical dimension of the bumper 5 can be set smaller in the upper-lower direction. Therefore, the vertical dimension of the bumper 5c, 5d can be minimized in the upper-lower direction. This makes it possible to downsize the parts and to reduce the weight.

A portion of the bumper 5 that is located between the upper grille 9 and the lower grille 10 has the ridge line L extending in the vehicle width direction and serving as a boundary, and includes the first surface 5c located below the ridge line L and the second surface 5d located above the ridge line L.

The license plate 20 is mounted over the first surface 5c and the second surface 5d.

This allows the license plate 20 to be mounted in two different directions, so that the mounting rigidity of the license plate 20 can be improved.

According to this embodiment, when viewed in a plane perpendicular to the vehicle width direction, the license plate 20 is mounted over the first surface 5c and the second surface 5d of the bumper 5 having different angles with respect to the upper-lower direction. Further, the first surface 5c and the second surface 5d of this embodiment intersect substantially at orthogonal angles.

Therefore, the license plate 20 has improved support for load applied from multiple directions. Accordingly, as compared with an alternative configuration in which the license plate 20 is mounted on a single plane, it is possible to enhance the mounting rigidity.

### Modified Embodiment

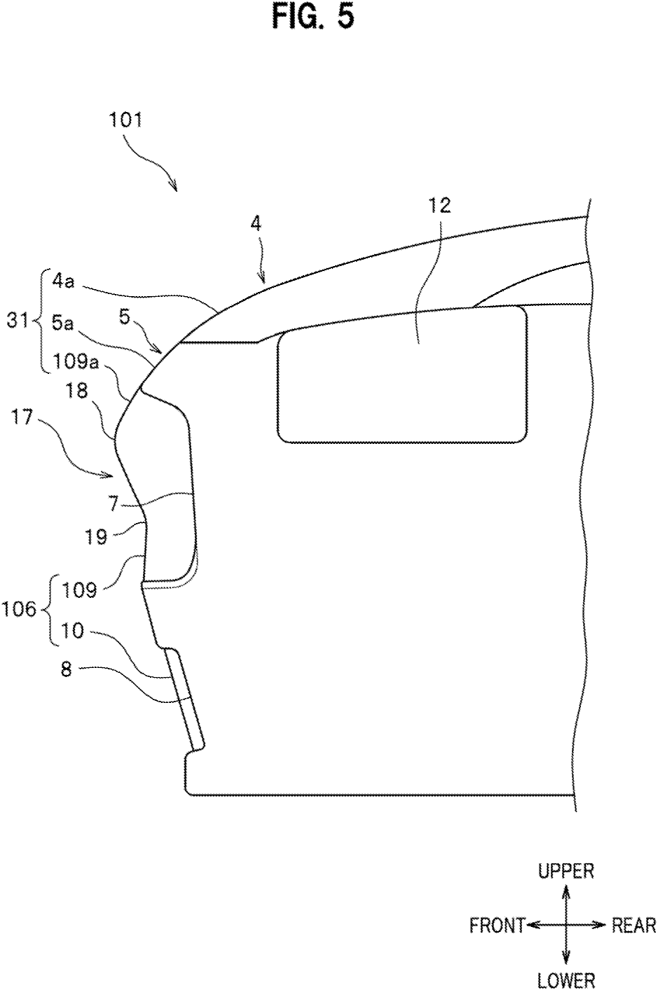

FIG. 5 is a left side view of a vehicle explaining a vehicle body front structure according to a modification of this embodiment, in which the hood 4, the bumper 5, and a grille 16 are attached to a vehicle 101. It should be noted that the same reference numerals are used for same or equivalent parts to those described in the above-described embodiment and explanation is focused mainly on different parts.

As seen in FIG. 5, the vehicle body front structure according to this modified embodiment includes a grill 106, and a surface 109a of an upper grill 109 is flush with the surface 5a of the bumper 5 and the inclination angles of these surfaces 109a, 5a are identical to each other.

Accordingly, each of the hood 4, the bumper 5, and the grille 106 of the vehicle 101 is at least partially provided with a flush surface portion 31 such that when viewed in a plane perpendicular to the vehicle width direction, positions of the surface 4a of the hood 4 and the surface 5a of the bumper 5 adjacent to each other or positions of the surface 5a of the bumper 5 and the surface 109a of the upper grille 109 adjacent to each other are flush with each other in an out-of-plane direction.

In addition to the operation and effects of the above embodiment, as seen in FIG. 5, according to the vehicle body front structure of this modified embodiment, each of the hood 4, the bumper 5, and the upper grille 109 has the flush surface portion 31 formed such that when viewed in a plane perpendicular to the vehicle width direction, positions of the surface 4a and the surface 5a adjacent to each other or positions of the surface 5a and the surface 109a of the upper grille 109 adjacent to each other are aligned in the same position in the out-of-plane direction.

As with the above embodiment, this can create continuity with other adjacently located parts and thus further improve external appearance quality. Further, according to this modified embodiment, continuity in design occurs at the flush surface portion 31 from the hood 4 to the grille 106 including the upper grille 109 and the lower grille 10 through the bumper 5. For this reason, the external appearance quality can be further improved at the front part of the vehicle 101.

Further, in this modified embodiment, the hood 4, the bumper 5, and the upper grille 109 adjacent to each other in the upper-lower direction of the vehicle are aligned such that the surfaces 4a, 5a, 109a thereof are flush with each other and curve continuously in an arc shape. Therefore, when a pedestrian is hit by the front side of the vehicle 1, he or she can be guided smoothly onto the hood 4.

Although embodiments of the present invention have been described above, the present invention is not limited to these specific embodiments and various changes and modifications may be made where appropriate without departing from the gist of the present invention.

In the above embodiments, the hood 4 is provided at the opening 3 above the power compartment E. However, the present invention is not limited to this specific configuration. For example, the opening 3 may be an opening of a vehicle compartment equipped with at least one of an engine or an electric motor (motor). Alternatively, the opening 3 may be an opening of a vehicle compartment that does not accommodate an engine and a motor. In other words, the shape, quantity, and material of the opening and the purpose of forming the opening are not limited to maintenance, etc.

The modified embodiment shown in FIG. 5 has been described with reference to the vehicle 101 having the flush surface portion 31, at which positions of the surface 4a and the surface 5a adjacent to each other or positions of the surface 5a and the surface 9a adjacent to each other are flush with each other in the out-of-plane direction. However, the present invention is not limited to this specific configuration.

For example, the surface 9a of the grille 6 may protrude beyond the surface 5a in the out-of-plane direction. In other words, as long as an identically inclined surface portion is at least partially provided such that the surfaces 9a, 5a adjacent to each other are inclined at an identical inclination angle, it is not necessary that the surfaces 9a, 5a are flush with each other to form the flush surface portion 31. As described above, the shape, quantity, material and combination of adjacent parts are not limited.

Further, angles of adjacent surfaces at the identically inclined surface portion may be different by several to several tens of degrees to such an extent that the adjacent surfaces can be recognized as identical in appearance, as long as they are inclined at an approximately identical inclination angle.

Further, according to this embodiment, the upper grille 9 includes a plurality of main pillars 17. However, the present invention is not limited to this specific configuration.

As long as the grille 6 has the identically inclined surface portion 11 inclined at an approximately identical inclination angle with that of the hood 4 or the bumper 5, the shape, quantity, and material of the main pillars 17 are not particularly limited.

Reference Signs List

| | |
|---|---|
| 1 | vehicle |
| 2 | front side |
| 3 | opening |
| 4 | hood |
| 5 | bumper |
| 6 | grille |
| 11 | identically inclined surface portion |

1. A vehicle body front structure comprising:
a hood provided at an opening formed in a front part of a vehicle;
a bumper located more frontward than the hood; and
a grille provided as a part of the bumper,
wherein each of the hood, the bumper, and the grille is at least partially provided with an identically inclined surface portion such that when viewed in a plane perpendicular to a vehicle width direction of the vehicle, surfaces of the hood, the bumper, and the grille that are adjacent to each other are inclined at an approximately identical inclination angle,
wherein the grille includes a main pillar extending in an upper-lower direction, and the main pillar has a first curved portion that curves to protrude forward at a middle portion of the main pillar in the upper-lower direction, and
wherein the main pillar of the grille has a second curved portion that curves to protrude rearward under the first curved portion.

2-3. (canceled)

4. The vehicle body front structure according to claim 1, wherein each of the hood, the bumper, and the grille is at least partially provided with a flush surface portion such that when viewed in a plane perpendicular to the vehicle width direction, positions of surfaces of the hood, the bumper, and the grille that are adjacent to each other are flush with each other in an out-of-plane direction.

5. The vehicle body front structure according to claim 1, wherein the bumper has a ridge line that protrudes frontward and extends in the vehicle width direction, and
wherein the license plate is supported by the bumper through an attachment fixture mounted astride the ridge line L in the upper-lower direction.

6. The vehicle body front structure according to claim 4, wherein the bumper has a ridge line that protrudes frontward and extends in the vehicle width direction, and
wherein the license plate is supported by the bumper through an attachment fixture mounted astride the ridge line L in the upper-lower direction.
